(19) United States
(12) Patent Application Publication
(10) Pub. No.: US 2012/0101734 A1
(43) Pub. Date: Apr. 26, 2012

(54) Method of Predicting Placebo Non-Response

(75) Inventor: Matthew Menza, Martinsville, NJ (US)

(73) Assignee: UNIVERSITY OF MEDICINE AND DENTISTRY OF NEW JERSEY, Somerset, NJ (US)

(21) Appl. No.: 13/277,336

(22) Filed: Oct. 20, 2011

Related U.S. Application Data
(60) Provisional application No. 61/405,092, filed on Oct. 20, 2010.

(51) Int. Cl. G06F 19/00

(52) U.S. Cl. 702/19

(57) ABSTRACT

The present invention provides a method of reliably predicting the likelihood of a response to placebo among subjects in, or potentially enrolling in, clinical trials.

### RELATIONSHIP TO PRIOR APPLICATIONS

This application claims priority to U.S. Provisional Patent Application No. 61/405,092, filed on Oct. 20, 2010, which is hereby incorporated by reference in its entirety.

### STATEMENT OF FEDERAL FUNDING

This invention was funded in part by Grant R01 NSO43144 awarded by the National Institute of Neurological Disorders and Stroke, of the National Institutes of Health. Therefore the U.S. government retains certain rights in this invention.

### FIELD OF THE INVENTION

The present invention relates to a method to reliably predict subjects' response to placebo to be used in clinical trials.

### BACKGROUND OF THE INVENTION

Placebo response occurs in roughly 30% of many placebo controlled trials of new medications—making separation from placebo difficult with respect to efficacy outcomes. The percentage of placebo response can be as high as 40% of patients in clinical trials concerning central nervous system disorders and is especially challenging in depression research. To date, there are no reliable predictors of who will or will not respond to placebo. Thus, there remains a need for cost-effective and reliable methods of predicting a subject's likelihood of responding to placebo, in order to ensure the most accurate clinical trial results.

### SUMMARY OF THE INVENTION

The present invention relates to a method to reliably predict subjects' response to placebo to be used in clinical trials. It has been demonstrated in a controlled trial in which the response to placebo was powerfully predicted by levels of the inflammatory cytokine, tumor necrosis factor alpha (TNF-α). It will be especially useful with trials for CNS disorders and treatments, including, but not limited to, depression, bipolar disorder, schizophrenia and somatoform disorders like fibromyalgia and pain. These trials frequently fail due to high placebo response rates, yielding inaccurate results and potentially keeping effective drugs off the market. The present invention allows for exclusion of patients who are likely to respond to placebo, thereby increasing the chances of a successful and accurate trial. It addresses the need for cost-effective and reliable methods of predicting a subject's likelihood of responding to placebo, thereby ensuring the most accurate clinical trial results. Furthermore, the advantage the present invention will provide to sponsors of clinical trials is considerable, as Phase III clinical trials require a great deal of money and time. This will allow sponsors to differentiate active drug effects from placebo response and save trials, resources and time.

In one embodiment, the present invention relates to a method of predicting the likelihood of response to placebo of a subject in or enrolling in a clinical trial, based on levels of TNF-α.

In another embodiment, the present invention is a research tool to further study and elucidate the mechanism of placebo response.

### DESCRIPTION OF THE PREFERRED EMBODIMENTS

The present invention relates to a method of predicting, reliably and accurately, the likelihood of a response to placebo among subjects in, or potentially enrolling in, clinical trials. It will be especially useful with trials for CNS disorders and treatments, including, but not limited to, depression, bipolar disorder, schizophrenia and somatoform disorders like fibromyalgia and pain. These trials frequently fail due to high placebo response rates, yielding inaccurate results, in addition to delaying or preventing new treatments' entry into the market. The present invention allows for exclusion of patients who are likely to respond to placebo, thereby increasing the chances of a successful and accurate trial. It also provides a novel route for research and may lead to significant progress in the understanding of placebo response (or placebo non-response).

There are numerous lines of evidence that relate cytokine exposure in animals to the clinical expression of depression in humans. Cytokine exposure in experimental models can generate a syndrome called “sickness behavior” which has compelling similarity to the pathophysiology of depression. For example, TNF-α and IL-1β elicit fatigue, anorexia, anhedonia and soporific effects, and severe depressive illness is accompanied by signs of immune activation and by elevations of cytokine production or levels.

Many CNS disorders are heterogeneous in their pathophysiology. Within any group of patients with depression (or other disorders diagnosed largely on the basis of subjective reporting), there may be some with high levels and some with low levels of inflammatory processes. The finding which is essential to the present invention is that high levels of TNF-α inhibit placebo response in depressed patients. The mechanism of this can be attributed to, at least partly, the phenomenon that individuals who feel “sick” from high levels of inflammatory cytokines will be less likely to respond to placebo.

There are numerous potential applications for this invention, particularly in CNS disorders like depression, bipolar disorder, schizophrenia and somatoform disorders like fibromyalgia and pain. High placebo response rates are a frequent cause of failed trials in these disorders. It is difficult to show efficacy for a new drug (compared to placebo) if 30-40% of patients on placebo respond. This invention would allow for exclusion of patients who are likely to respond to placebo, thus increasing the likelihood of a successful trial. Practice of the present invention has several possible frameworks, including a screening run-in, in which those with low levels of TNF-α are excluded from the subsequent trial.

In one embodiment, the present invention relates to a method of predicting the likelihood of response to placebo of a subject in or enrolling in a clinical trial, based on levels of TNF-α. This method entails measuring the level of tumor necrosis factor-a in each subject enrolled in or potentially enrolling in a clinical study, by any of the standard clinical assays to determine one's TNF-α levels; determining if is high or low, using a predetermined range of levels; selecting subjects with high levels of tumor necrosis factor- a; and excluding subjects with low levels of tumor necrosis factor-α. The threshold level for assessing one's level of TNF-α is approximately twenty (20) picograms/milliliter. Therefore a subject whose assay reveals a level of TNF-α equal to or greater than 20 pg/mL would be considered to have a “high” TNF-α level and would be predicted to not respond to placebo. A subject with a TNF-α level of less than 20 pg/mL would be characterized as having a “low” level of TNF-α and would be predicted to be likely to respond to placebo.

In another embodiment, the present invention is a tool to further study and elucidate the mechanism of placebo response. By providing a correlation between TNF-α and the likelihood of a study subject to respond to placebo, this invention gives clinical researchers a novel route to understanding the mechanism and physiological causes of placebo response. Cytokine exposure in animals has been linked to the clinical expression of depression in humans, For example, TNF-α and IL-1β elicit fatigue, anorexia, anhedonia and soporific effects, and severe depressive illness is accompanied by signs of immune activation and by elevations of cytokine production or levels. Although most CNS disorders are heterogeneous in their pathophysiology, the present invention establishes the link that high levels of TNF-α inhibit placebo response in depressed patients and provides a novel route for understanding the placebo response.

In an NIH randomized controlled trial of antidepressants in patients with Parkinson's disease and depression, of the 15 patients on placebo, none with high levels of TNF-α responded to placebo, while the typical 37% of those with low TNF-α did respond to placebo. Within the drug treatment groups TNF-α did not predict response or non-response. Table 1 represents the effect of TNF-α on response rates. Response was defined as a 50% or greater decrease in score on the Hamilton Depression Rating Scale. It demonstrates that TNF-α accurately predicts placebo response and has no correlation with drug response.

TABLE 1
Effect of TNF-α on Placebo Response Rates

| TNF-α | Nortriptyline | Paroxetine | Placebo | Significance |
|---|---|---|---|---|
| High | 50% | 40% | 0% | .0071 |
| Low | 57% | 9% | 37.5% | |

A panel of cytokines was studied, which included IL-1β, IL-6, IL-10, TNF-α, along with cortisol, in 52 patients with Parkinson's Disease and depression. There were significant correlations between non-motor symptoms and TNF-α. TNF-α was found to correlate at baseline with multiple measures of cognition, depression, sleep, disability and quality of life, whereas the remaining cytokines from the panel did not. Furthermore, TNF-α was a consistent indicator of variance in depression, sleep and disability.

Although the invention herein has been described with reference to particular embodiments, it is to be understood that these embodiments are examples of the principles and applications of the present invention. Furthermore, numerous modifications may be made to the these embodiments and other arrangements may be devised without departing from the spirit and scope of the present invention as defined by the claims appended hereto.

### EXAMPLES

The present invention is described more fully by way of the following non-limiting examples. Modifications of these examples will be apparent to those skilled in the art.

### Example 1

### Effect of TNF-α on Trial Response Rates

In an NIH randomized controlled trial of antidepressants in patients with Parkinson's disease and depression, of the 15 patients on placebo, none with high levels of TNF-α responded to placebo, while the typical 37% of those with low TNF-α did respond to placebo. Specifically, TNF-α was measured at baseline in all patients. A regression analysis, with all relevant variables accounted for, showed a statistically significant (P=0.0013) relationship between TNF-α and response only in the placebo group. Within the drug treatment groups TNF-α did not predict response or non-response. It demonstrated that TNF-α accurately predicts placebo response and has no correlation with drug response. The overall response rates in the trial were as follows: Nortriptyline-53%, Paroxetine-11% and placebo-24%.

The data are available in the clinical trial records for the trial, “A Controlled Trial of Antidepressants in Patients with Parkinson's Disease and Depression.” This study was supported by a grant from the National Institute of Neurologic Disorders and Stroke (NINDS) RO1NS043144. Clinical Trials Registration: Clintrials.gov Identifier: NCT 00062738. The database is currently held by Matthew Menza, MD.

### Example 2

### Correlation of TNF-α to Mental and Emotional States

Cytokine levels were measured in 52 patients with Parkinson's Disease and depression. The panel included IL-1β, IL-6, IL-10, TNF-α and cortisol. TNF-α correlated at baseline with multiple measures of cognition, depression, sleep, disability and quality of life and was a consistent indicator of variance in depression, sleep and disability. The remaining cytokines from the panel showed no such correlation.

The foregoing examples and description of the preferred embodiments should be interpreted as illustrating, rather than as limiting the present invention as defined by the claims. All variations and combinations of the features above are intended to be within the scope of the following claims.

What is claimed is:

1. A method of predicting the likelihood of placebo response of a subject in a clinical research trial comprising measuring the level of tumor necrosis factor-α in said subject by any of the standard clinical assays to determine one's TNF-α levels.

2. A method of selecting suitable subjects for clinical research trials, by predicting the likelihood of placebo response of each subject.

3. A kit facilitating the practice of claim 1 comprising instructions and categorization of the range of levels of tumor necrosis factor-α as low or high and the subsequent action of excluding or including the subject in the clinical study.
